(19) United States
(12) Patent Application Publication
(10) Pub. No.: US 2011/0161128 A1
(43) Pub. Date: Jun. 30, 2011

(54) Scheduling and Assigning Units of Work

(75) Inventors: Roschelle Barney, Angier, NC (US); Christopher Schmitt, Clewiston, FL (US); Jnani Clay, Indianapolis, IN (US)

(73) Assignee: McKesson Financial Holdings Limited

(21) Appl. No.: 12/651,021

(22) Filed: Dec. 31, 2009

(51) Int. Cl. G06Q 10/00; G06F 3/048

(52) U.S. Cl. 705/7.13; 705/301; 715/764

(57) ABSTRACT

Systems, methods, and computer program products are provided for scheduling and assigning worker profiles to units of work. For example, in one embodiment, a scheduling system ensures that (a) workers are appropriately qualified to complete or perform units of work, (b) scheduling conflicts on a workers' schedule are avoided, and (c) customizable rules and guidelines are followed with respect to assigning the units of work.

### BACKGROUND

When scheduling workers for work assignments, it is often difficult to assign workers to work assignments while ensuring that (a) the workers are appropriately qualified to complete the work assignments, (b) scheduling conflicts are avoided, and (c) customizable rules and guidelines are followed. Thus, a need exists for providing a solution that can fulfill the above-identified needs.

### BRIEF SUMMARY

In general, embodiments of the present invention provide systems, methods, apparatus, and computer program products for scheduling and assigning units of work.

In accordance with one aspect, a computer-implemented method is provided. In one embodiment, the computer-implemented method comprises (a) electronically storing a plurality of worker profiles corresponding respectively to a plurality of workers; (b) electronically storing one or more worker groups, wherein each of the one or more worker groups is associated with a plurality of worker profiles; (c) electronically storing a first rule that requires compliance with for a worker profile to be assigned to a unit of work; and (d) electronically storing a second rule that requires authorization for a worker profile to be assigned to a unit of work. The method also comprises (e) receiving input defining a plurality of units of work; (f) receiving input identifying a user associated with a user profile; (f) receiving input requesting execution of an automated scheduling operation, wherein execution of the automated scheduling function comprises (1) electronically identifying at least one worker group associated with the user profile and (2) receiving input selecting a worker profile from the worker group for scheduling; (g) receiving input assigning the worker profile to the assignable unit of work; and (h) in response to receiving input assigning the worker profile to the assignable unit of work that would require authorization to be in compliance with the second rule, generating a request to (1) authorize or (2) deny the assignment of the worker profile to the assignable unit of work. In one embodiment, the method also comprises (i) receiving input authorizing the assignment of the worker profile to the assignable unit of work; and (j) updating, via the one or more processors, the worker profile to reflect the assignment of the assignable unit of work.

In accordance with another aspect, a computer-implemented method is provided. In one embodiment, the computer-implemented method comprises (a) electronically storing a plurality of worker profiles corresponding respectively to a plurality of workers; (b) electronically storing one or more worker groups, wherein each of the one or more worker groups is associated with a plurality of worker profiles; (c) electronically storing a first rule that requires compliance with for a worker profile to be assigned to a unit of work; and (d) receiving input defining a plurality of units of work. In one embodiment, the method also comprises (e) receiving input identifying a user associated with a user profile; and (f) receiving input requesting execution of an automated scheduling operation.

In accordance with yet another aspect, a computer program product is provided. The computer program product may comprise at least one computer-readable storage medium having computer-readable program code portions stored therein, the computer-readable program code portions comprising executable portions configured to (a) store a plurality of worker profiles corresponding respectively to a plurality of workers; (b) store one or more worker groups, wherein each of the one or more worker groups is associated with a plurality of worker profiles; (c) store a first rule that requires compliance with for a worker profile to be assigned to a unit of work; and (d) store a second rule that requires authorization for a worker profile to be assigned to a unit of work. In one embodiment, the computer-readable program code portions may also comprise executable portions configured to (e) receive input defining a plurality of units of work; (f) receive input identifying a user associated with a user profile; (g) receive input requesting execution of an automated scheduling operation, wherein execution of the automated scheduling function comprises (1) electronically identifying at least one worker group associated with the user profile and (2) receiving input selecting a worker profile from the worker group for scheduling; and (h) receive input assigning the worker profile to the assignable unit of work. The computer-readable program code portions may also comprise executable portions configured to (i) in response to receiving input assigning the worker profile to the assignable unit of work that would require authorization to be in compliance with the second rule, generate a request to (1) authorize or (2) deny the assignment of the worker profile to the assignable unit of work; (j) receive input authorizing the assignment of the worker profile to the assignable unit of work; and (k) update the worker profile to reflect the assignment of the assignable unit of work.

In accordance with still another aspect, a computer program product is provided. The computer program product may comprise at least one computer-readable storage medium having computer-readable program code portions stored therein, the computer-readable program code portions comprising executable portions configured to (a) store a plurality of worker profiles corresponding respectively to a plurality of workers; (b) store one or more worker groups, wherein each of the one or more worker groups is associated with a plurality of worker profiles; (c) store a first rule that requires compliance with for a worker profile to be assigned to a unit of work; and (d) receive input defining a plurality of units of work. The computer-readable program code portions may also comprise executable portions configured to (e) receive input identifying a user associated with a user profile; and (f) receive input requesting execution of an automated scheduling operation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a management system according to various embodiments of the present invention.

FIG. 2 is an exemplary schematic diagram of a scheduling system according to one embodiment of the present invention.

FIGS. 3-5 are flowcharts illustrating operations and processes that can be used in accordance with various embodiments of the present invention.

FIGS. 6-26 are universal input and output produced by one embodiment of the invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout.

### I. METHODS, APPARATUS, SYSTEMS, AND COMPUTER PROGRAM PRODUCTS

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. EXEMPLARY SYSTEM ARCHITECTURE

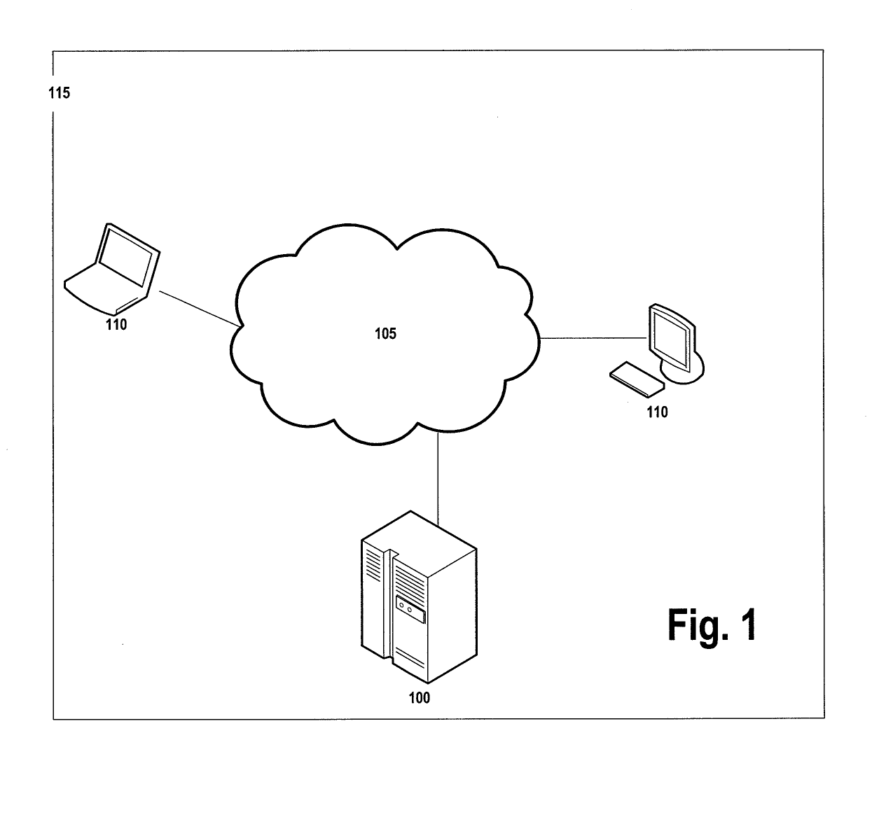

FIG. 1 provides an illustration of a management system 115 that can be used in conjunction with various embodiments of the present invention. As shown in FIG. 1, the management system 115 may include a scheduling system 100, a network 105, and one or more user computing devices 110. Each of the components of the management system 115 may be in electronic communication with, for example, one another over the same or different wireless or wired networks including, for example, a wired or wireless Personal Area Network (“PAN”), Local Area Network (“LAN”), Metropolitan Area Network (“MAN”), Wide Area Network (“WAN”), or the like. Additionally, while FIG. 1 illustrates the various system entities as separate, standalone entities, the various embodiments are not limited to this particular architecture.

### 1. Scheduling System

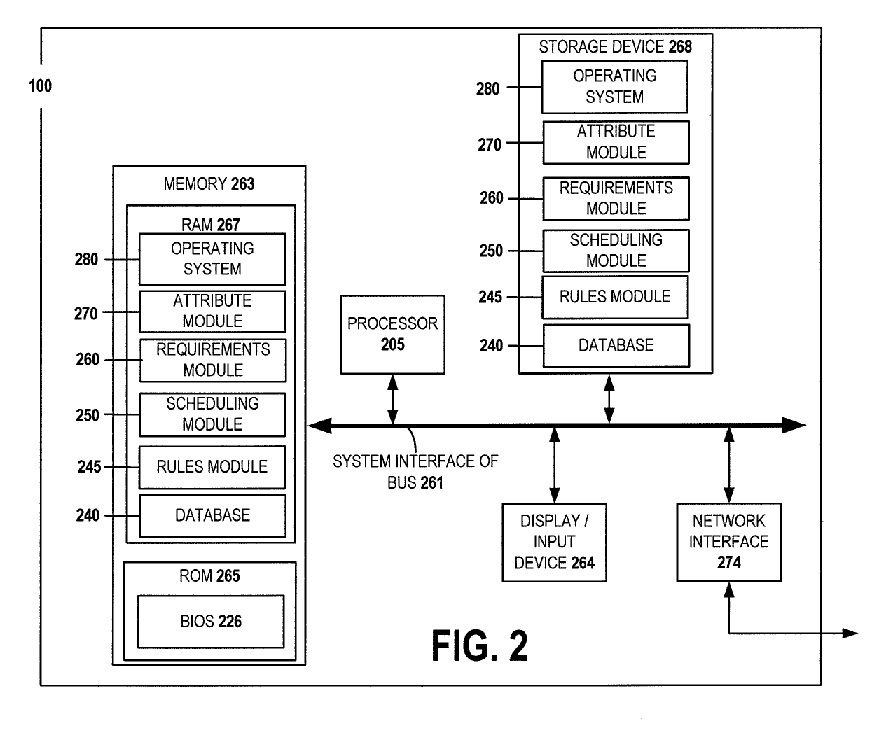

FIG. 2 provides a schematic of a scheduling system 100 according to one embodiment of the present invention. In general, the term “system” may refer to, for example, any computer, computing device, desktop, notebook or laptop, distributed system, server, gateway, switch, or other processing device adapted to perform the functions described herein. As will be understood from this figure, in this embodiment, the scheduling system 100 includes a processor 205 that communicates with other elements within the scheduling system 100 via a system interface or bus 261. The processor 205 may be embodied in a number of different ways. For example, the processor 205 may be embodied as various processing means such as a processing element, a coprocessor, a controller or various other processing devices including integrated circuits such as, for example, an application specific integrated circuit (“ASIC”), a field programmable gate array (“FPGA”), a hardware accelerator, or the like.

In an exemplary embodiment, the processor 205 may be configured to execute instructions stored in the device memory or otherwise accessible to the processor 205. As such, whether configured by hardware or software methods, or by a combination thereof, the processor 205 may represent an entity capable of performing operations according to embodiments of the present invention while configured accordingly. A display device/input device 264 for receiving and displaying data is also included in the scheduling system 100. This display device/input device 264 may be, for example, a keyboard or pointing device that is used in combination with a monitor. The scheduling system 100 further includes memory 263, which may include both read only memory (“ROM”) 265 and random access memory (“RAM”) 267. The scheduling system's ROM 265 may be used to store a basic input/output system (“BIOS”) 226 containing the basic routines that help to transfer information to the different elements within the scheduling system 100.

In addition, in one embodiment, the scheduling system 100 includes at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or the like. Additionally, each of these storage devices 268 may be connected to the system bus 261 by an appropriate interface.

Furthermore, a number of program modules may be stored by the various storage devices 268 and/or within RAM 267. Such program modules may include an operating system 280, an attribute module 270, a requirements module 260, a scheduling module 250, and a rules module 245. These modules may control certain aspects of the operation of the scheduling system 100 with the assistance of the processor 205 and operating system 280—although their functionality need not be modularized. In addition to the program modules, the scheduling system 100 may store or be connected to one or more databases (e.g., database 240) with one or more tables stored therein.

Also located within the scheduling system 100, in one embodiment, is a network interface 274 for interfacing with various computing entities. This communication may be via the same or different wired or wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the scheduling system 100 may be configured to communicate via wireless external communication networks using any of a variety of protocols, such as 802.11, general packet radio service (“GPRS”), wideband code division multiple access (“W-CDMA”), or any other wireless protocol.

It will be appreciated that one or more of the scheduling system's 100 components may be located remotely from other scheduling system 100 components. Furthermore, one or more of the components may be combined and additional components performing functions described herein may be included in the scheduling system 100.

### 2. Additional Exemplary System Components

The user computing devices 110 may each include one or more components that are functionality similar to those of the scheduling system 100. For example, in one embodiment, each of the user computing devices may include: (1) a processor that communicates with other elements via a system interface or bus; (2) a display device/input device; (3) memory including both ROM and RAM; (4) a storage device; and (5) a network interface. These architectures are provided for exemplary purposes only and are not limiting to the various embodiments. The term “computing device” is used generically to refer to any computer, computing device, desktop, notebook or laptop, distributed system, server, gateway, switch, or other processing device adapted to perform the functions described herein.

### III. EXEMPLARY SYSTEM OPERATION

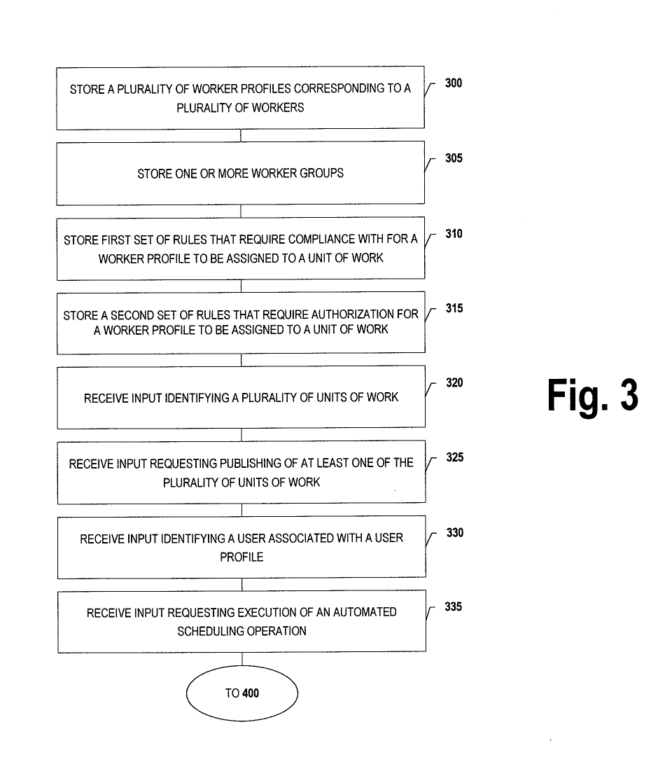

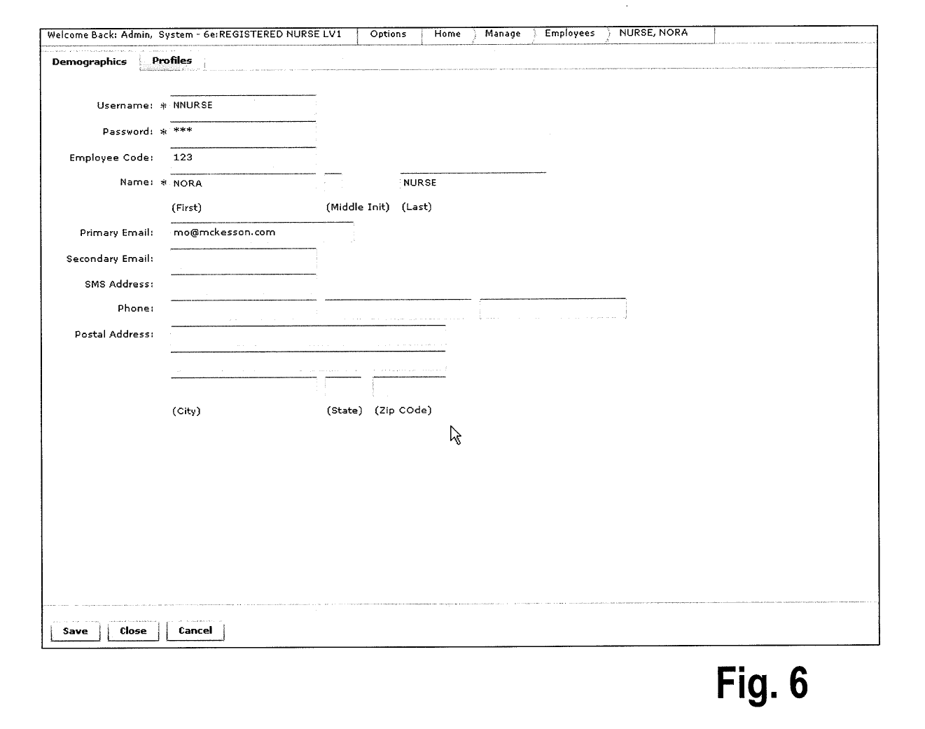

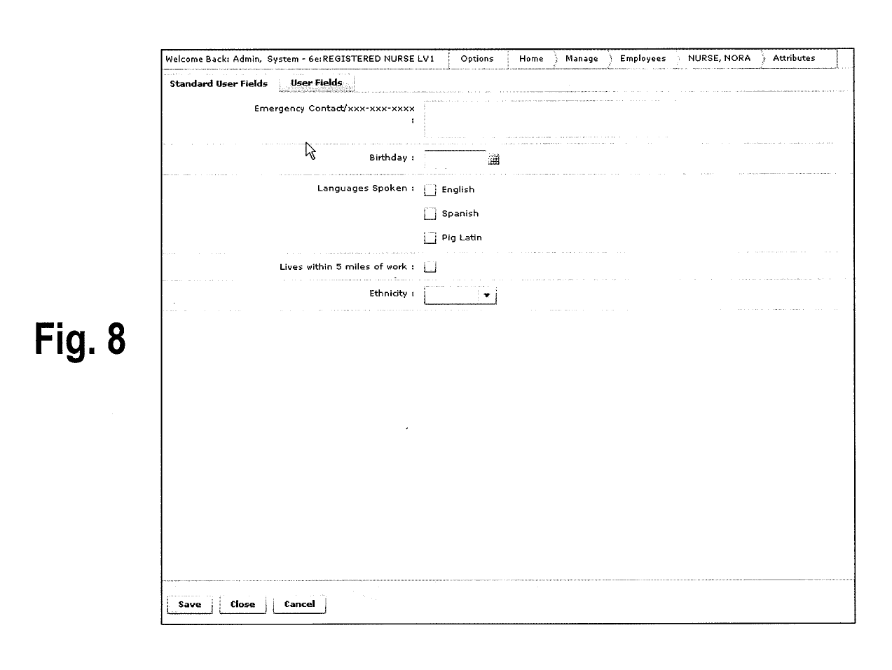

Reference will now be made to FIGS. 3-26. FIGS. 3-5 provide flowcharts illustrating operations that may be performed to schedule and assign units of work. FIGS. 6-26 show universal input and output produced by one embodiment of the invention.

### 1. Workers and Worker Profiles

In one embodiment (Block 300), the scheduling system 100 electronically stores worker profiles (e.g., in a database 240) that correspond respectively to workers (e.g., people who can be assigned to units of work). For example, a worker profile corresponding to a worker can be used to store attributes associated with the worker that may assist in scheduling the worker to perform units of work. A unit of work may be, for example, (a) a shift at a hospital, (b) a repair at an automotive repair shop, (c) attending a conference as a representative of a corporation, (d) delivering flower arrangements for a florist, or (e) a variety of other tasks/jobs. The worker profiles can be created and edited for storage by the scheduling system 100 via, for example, user computing devices 110.

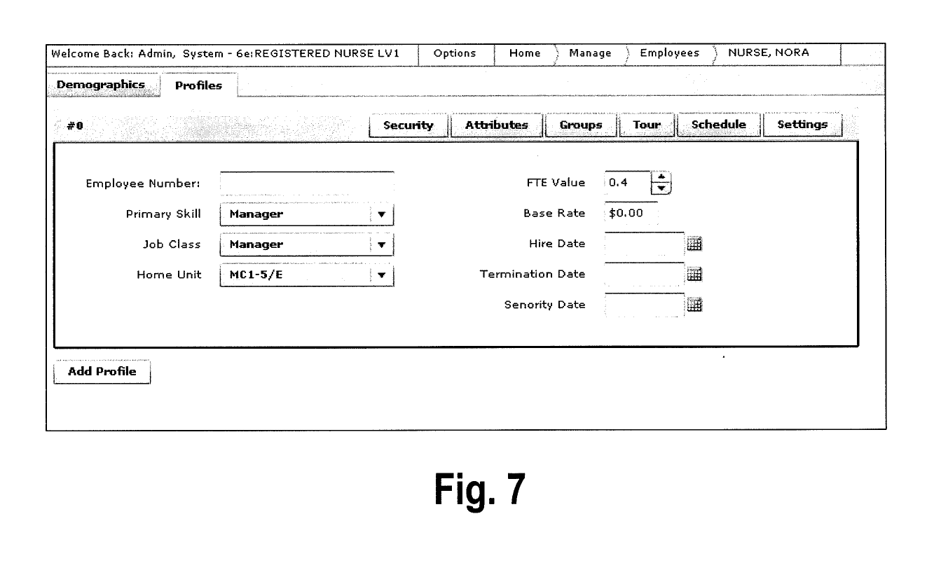

In one embodiment, each worker is associated with a worker profile. The attributes stored in the worker profiles (e.g., via an attribute module 270) may be customized based on the nature of the associated units of work. For example, as shown in FIG. 6, a worker profile may include a worker's (a) username to access the scheduling system 100, (b) password to access the scheduling system 100, (c) employee identification number, (d) name, (e) email addresses, (f) short message service (“SMS”) addresses, (g) phone numbers, and (h) residential address. In addition to biographical information, as shown in FIG. 7, the worker profile may also comprise the worker's (i) primary skill (e.g., manager, nurse, doctor, or mechanic), (j) work/job class (e.g., a nurse may be a neonatal nurse, a nurse anesthetist, or an occupational health nurse), (k) home team of workers (e.g., the worker's department), (1) full-time equivalent value, (m) base rate of pay, (n) hire date, (o) termination date, and (p) seniority date. Similarly, the worker profile may also comprise the worker's (q) emergency contact information, (r) birthday, (s) languages spoken, (t) driving distance to work, and (u) ethnicity. Although not shown, other information could also be stored within the worker profile, such as the worker's (v) certifications or licenses, (w) schedule preferences, (x) religious holidays observed, (y) allergies, and (z) physical limitations. This attribute information can be entered into the scheduling system 100 using radio buttons, drop down boxes, textual input, voice recognition software, and/or a variety of other approaches and techniques.

In one embodiment, a worker may be associated with more than one worker profile. Similarly, a worker profile may comprise sub-profiles. For example, a worker with multiple primary skills (e.g., a worker who is both a paramedic and an emergency room attendant) may have multiple worker profiles or one worker profile with multiple sub-profiles to allow the worker to be assigned to units of work that require different primary skills.

In one embodiment, each worker profile is also associated with or assigned to one or more worker groups (Block 305), which can be stored by the scheduling system 100. The worker groups can be used to, for example, group workers (e.g., worker profiles) who (a) have similar primary skills, (b) work at the same facility, (c) work in the same department within a facility, (d) work on the same team of workers (e.g., the neonatal team or the emergency responders team), (e) who hold certain certifications (e.g., certifications in cardiopulmonary resuscitation or oncology), or (f) report to a common supervisor. For example, a worker group may comprise (a) the nurses in the neonatal unit at Good Health Hospital or (b) the automotive service excellence certified mechanics at the Friendly Toyota dealership. In one embodiment, the worker profiles are associated with or assigned to one or more worker groups to, for example, provide certain users with rights to edit the information in the worker profiles and/or assign worker profiles to units of work. For instance, the head of the neonatal unit at Good Health Hospital may be provided with rights to edit and assign, for example, the worker profiles of (a) all the neonatal nurses employed at the Good Health Hospital or (b) all pediatric nurses employed at the Good Health Hospital. The permutations of the work groups may vary and be customized to suit a variety of needs.

### 2. Users and User Profiles

In one embodiment, users of the scheduling system 100 have corresponding user profiles for accessing the scheduling system 100 (e.g., via user computing devices 110). The user profiles allow users to, for example, (a) edit and create worker profiles, (b) assign worker profiles to units of work, and/or (c) view units of work to which a worker has been assigned. In one embodiment, there are varying levels of user profiles with corresponding varying levels of access and rights with respect to the scheduling system 100. For example, a user profile may be an administrator profile, a manager profile, a coordinator profile, or a worker profile. An administrator profile may provide the corresponding user(s) with administrator level rights, such as the ability create worker profiles, establish rights for manager and coordinator profiles, create rules for a facility (or globally for an organization), and/or the like. Similarly, a manager profile may provide the corresponding user(s) with manager level rights, such as the ability to add workers to teams of workers (e.g., nurses assigned to a neonatal unit at a hospital), assign workers on multiple teams of workers to units of work, and edit worker profiles for certain worker groups. Additionally, a coordinator profile may provide the corresponding user(s) with coordinator level rights, such as the ability to add workers to home teams of workers, assign workers on multiple home teams of workers to units of work, and edit worker profiles for certain worker groups. And finally, a worker profile may provide the corresponding user(s) with worker level rights, such as the ability to view the user's work schedule and update the worker's schedule preferences. The user profiles can be created and edited for storage by the scheduling system 100 via, for example, user computing devices 110. The types of user profiles and their corresponding access and rights may vary and be customized to suit a variety of needs.

### 3. Rules and Sets of Rules

In one embodiment, the scheduling system 100 electronically stores rules or sets of rules for assigning worker profiles to units of work. The rules (or sets of rules) can be created, defined, edited, and stored by the scheduling system 100 (e.g., with the aid of one or more user computing devices 110). In one embodiment, the scheduling system 100 stores a first rule (or first set of rules) that must be complied with for a worker profile to be assigned to a unit of work (Block 310). For example, in one embodiment, for a worker profile to be assigned to a unit of work, the first rule (or first set of rules) can require compliance with a rule, such as (a) not allowing a worker profile to be assigned to work more than 16 hours in any 24-hour period or (b) not allowing any scheduling conflicts. In one embodiment, the scheduling system 100 also stores a second rule (or second set of rules) that requires authorization for a worker profile to be assigned to a unit of work (Block 315). For example, in one embodiment, for a worker profile to be assigned to a unit of work, the second rule can require authorization from an appropriate party, such as only allowing a worker profile to be assigned for overtime work if his supervisor authorizes the overtime.

In various embodiments, the rules or sets of rules can be used to provide global, regional, local, facility based, worker group based, or worker profile based guidelines and restrictions for assigning worker profiles to units of work. In other words, the rules (or the sets of rules) may vary and be implemented on various levels. For example, a user (e.g., via a user computing device 110) with an administrator profile may create, edit, and store a rules (or set of rules) that apply globally to an organization regardless of facility location or nature of the units of work (e.g., no overtime for any workers during the month of July). Similarly, a user (e.g., via a user computing device 110) may create, edit, and store rules (or sets of rules) that apply to a particular facility (e.g., no worker can be assigned to work more than 12 hours consecutively). Or, a user (e.g., via a user computing device 110) may create, edit, and store rules (or sets of rules) that apply to a particular team of workers (e.g., no worker may work more than 16 hours in a 24-hour period). The rules or (or sets of rules) can be customized to adapt to the needs of, for example, an organization, a facility, a team of workers, a worker profile, or a unit of work (e.g., via a rules module 245).

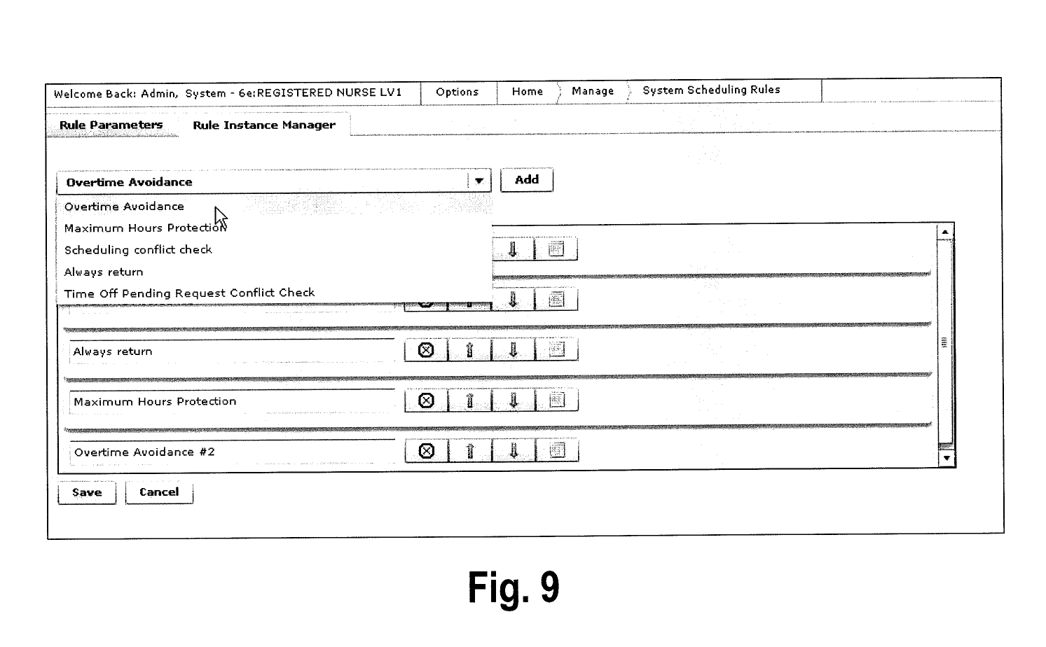

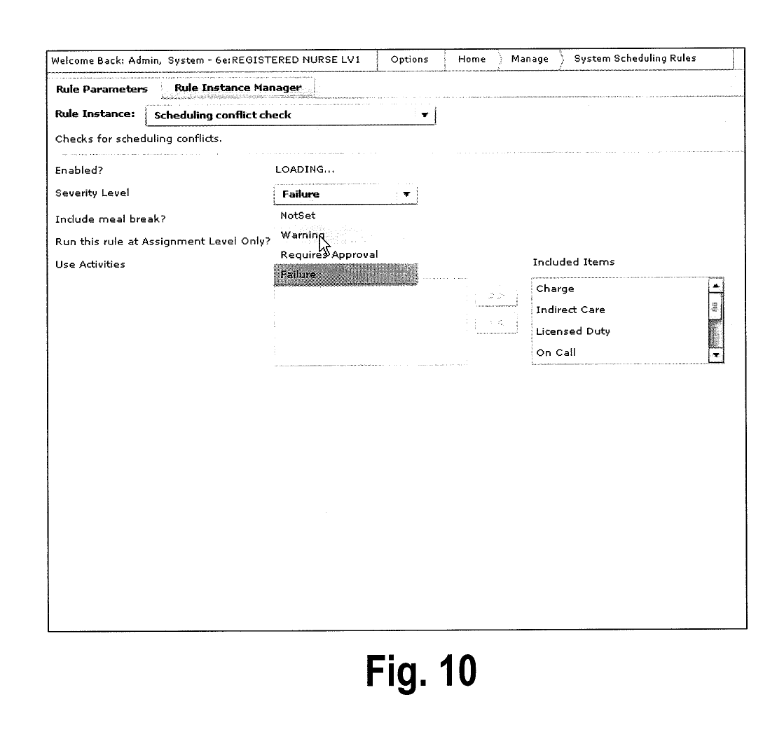

In one embodiment, the rules can be designed and tailored to meet various objectives. For example, as shown in FIG. 9, the rules (or sets of rules) may be directed to (a) avoiding or limiting overtime, (b) providing maximum hours policies, (c) avoiding scheduling conflicts, such as assigning a worker profile to conflicting units of work, and (d) complying with time-off requests. For each rule or sets of rules, a severity level can be set. For example, shown in FIG. 10, depending on the severity level, an infraction of a rule can indicate that a worker profile may (a) not be assignable to a unit of work (e.g., failure), (b) be assigned to a unit of work provided a warning is displayed to the user (e.g., via the user computing device 110) that a certain rule may be infracted, or (c) require authorization (e.g., from the worker's supervisor) for a worker profile to be assigned to a unit of work.

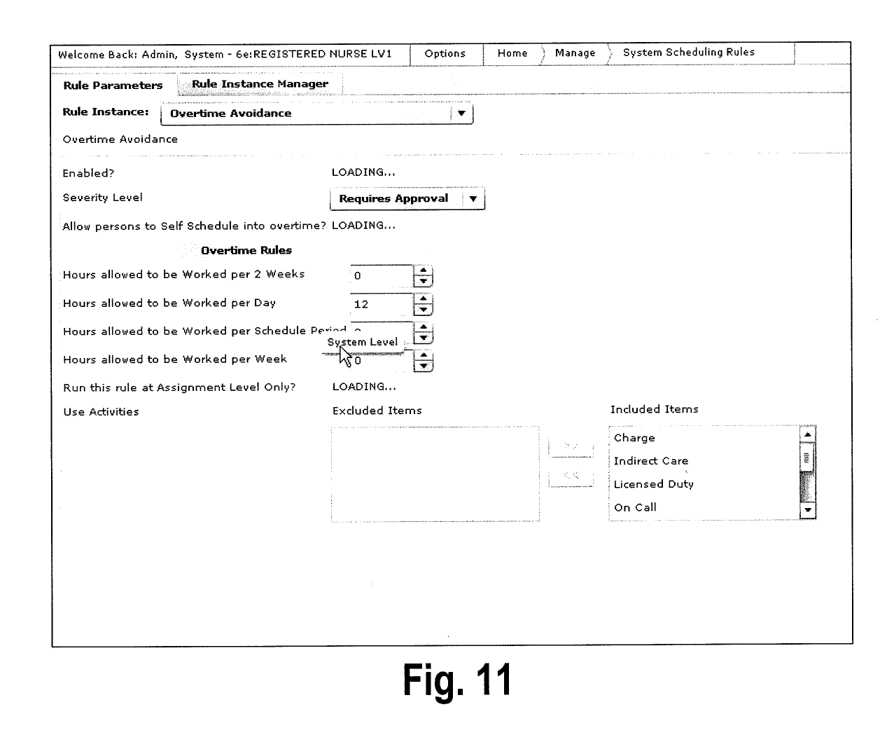

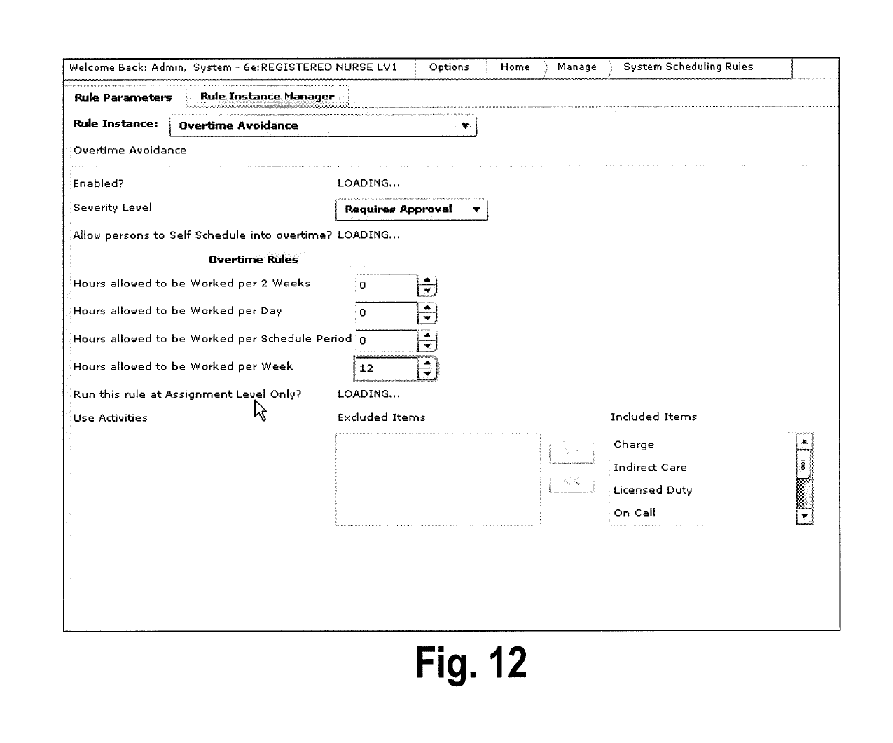

An illustrative rule is shown in FIGS. 11 and 12. In this example, the rule is an overtime avoidance rule. In one embodiment, the overtime avoidance rule allows the user (e.g., via a user computing device 110) to (a) enable the rule and (b) identify the severity level of the rule, e.g., require complete compliance with the rule, allowing infractions of the rule with warning, or allowing infractions of the rule with authorization. The particulars of the rule may include (a) defining the total number of hours a worker can work per two-week period, (b) defining the total number of hours a worker can work in 1 day, (c) defining the total number of hours a worker can work in a scheduling period, (d) defining the total number of hours a worker can work in 1 week, and (d) avoiding any scheduling conflicts of assigning a worker profile to conflicting units of work. Additionally, the rule can be configured to apply globally to, for example, an organization, a facility, or a team of workers. And finally, the rule can be configured to exclude certain units of work, such as emergency responses or on-call duty.

### 4. Units of Work

In one embodiment, the scheduling system 100 receives (e.g., via user computing devices 110) input defining one or more units of work (Block 320). As indicated previously, a unit of work may be, for example, (a) a shift at a hospital, (b) a repair at an automotive repair shop, (c) attending a conference as a representative of a corporation, (d) delivering flower arrangements for a florist, or (e) a variety of other tasks/jobs.

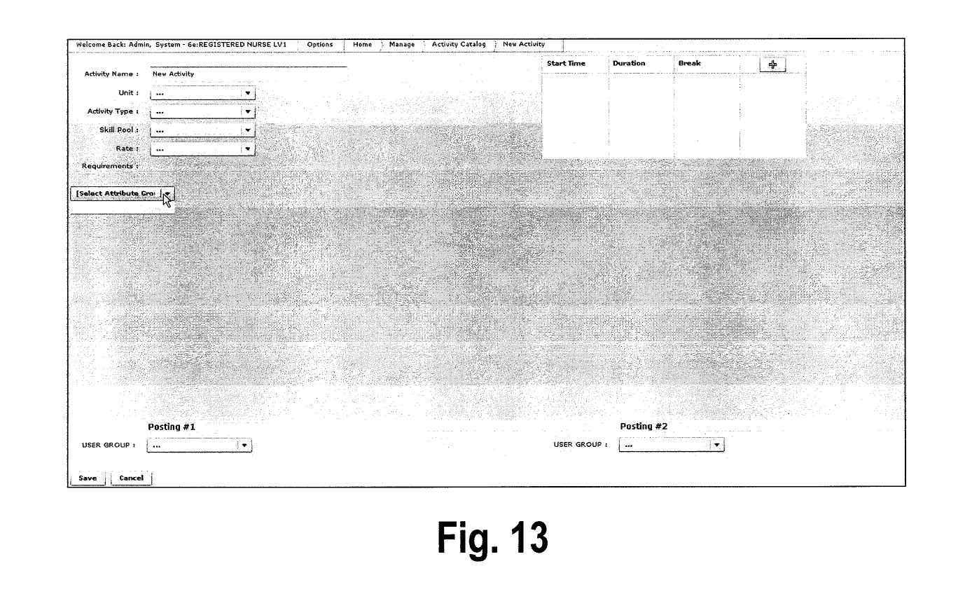

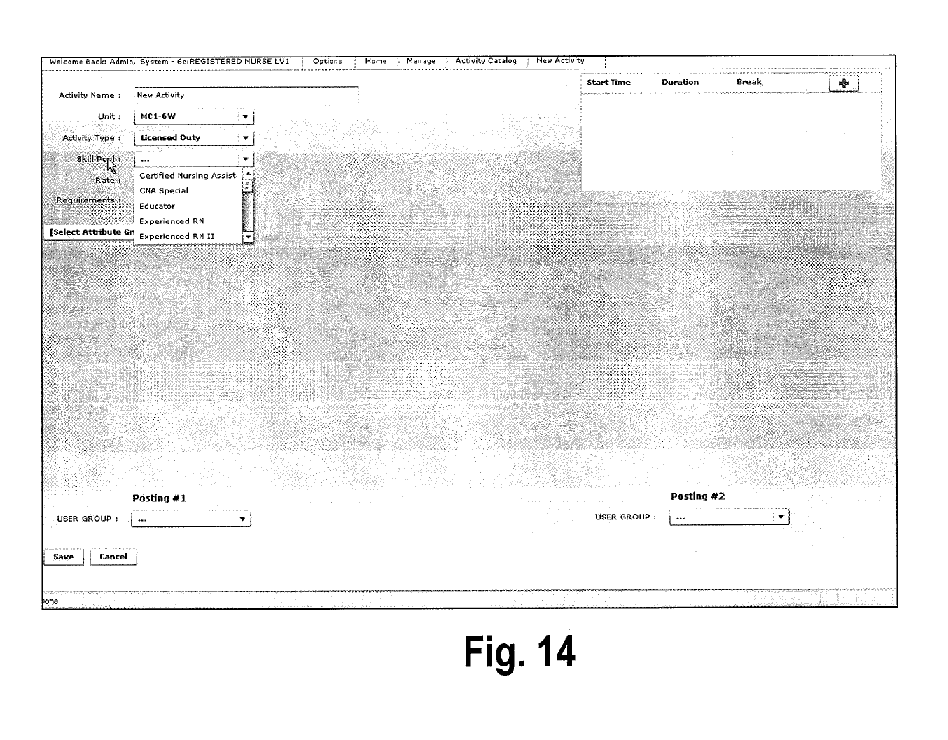

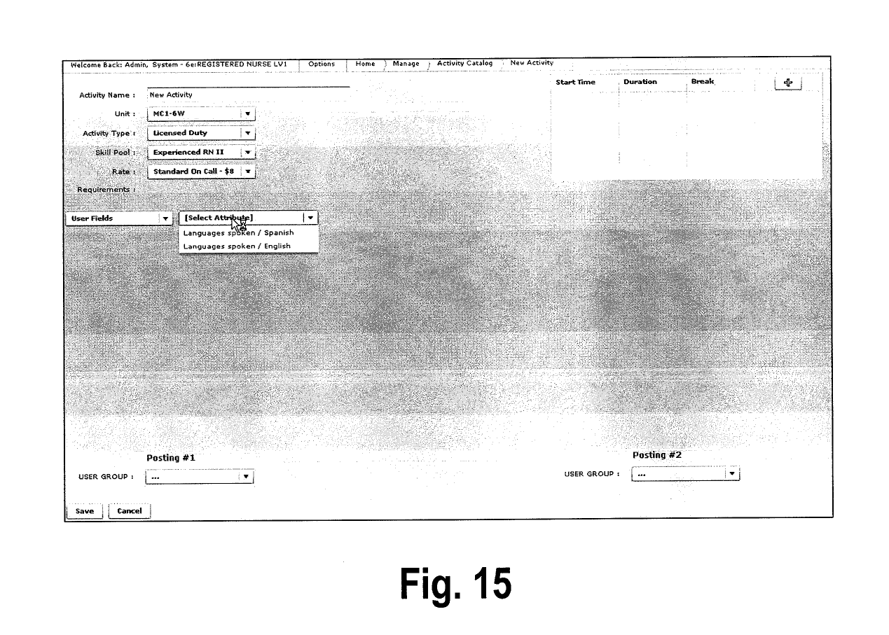

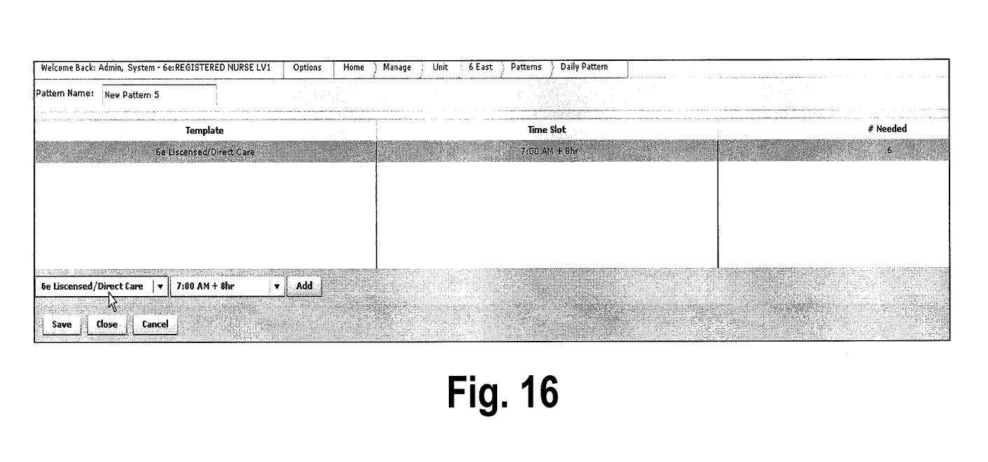

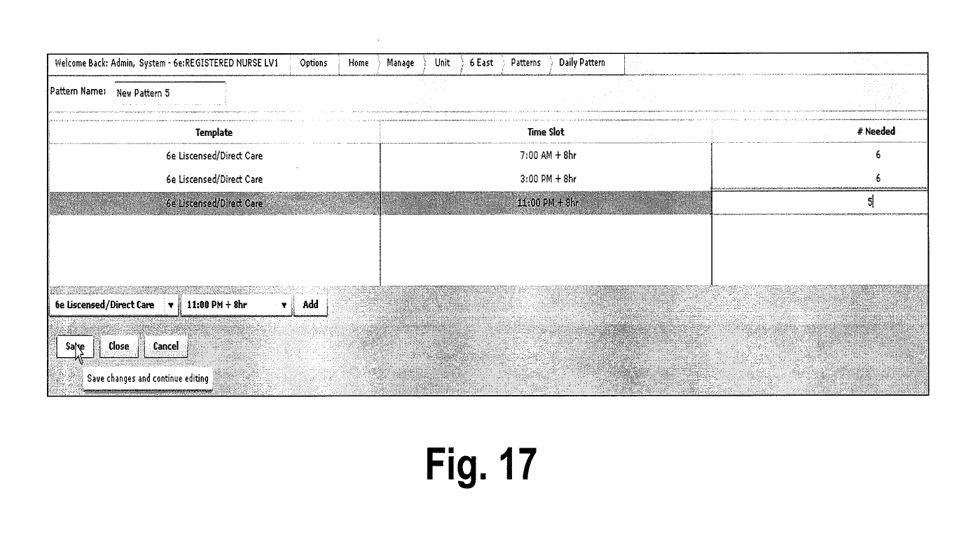

In one embodiment, to define the parameters of the units of work, each unit of work comprises work requirements associated with the unit of work. For example, as shown in FIG. 13, the work requirements for a unit of work may identify, for example, the (a) name of the unit of work, (b) location of the unit of work, (c) primary skill required, (d) work/job class, (e) date, (f) start time, (g) end time, (h) break times, (j) the base rate of pay. By way of example, as shown in FIG. 14, the primary skill defined by the work requirements may require that the primary skill of the worker be, for example, a certified nursing assistant, a CNA Special, Educator, Experienced RN, or an Experienced RN II. Furthermore, additional work requirements can be added to customize the work requirements for the unit of work. For example, as shown in FIG. 15, the work requirements can be customized to require that the worker (k) speak a specific language, (1) be assigned to a particular team of workers, (m) have a certain license or certification on the date of the unit of work, (n) live within a certain distance from work (e.g., for emergency responses), (o) or a variety of other options. Similarly, as shown in FIGS. 16 and 17, the work requirements may indicate the number of workers needed to be assigned to a particular unit of work, e.g., 6 licensed, direct care nurses need to be assigned to the 7:00 am shift that lasts eight hours.

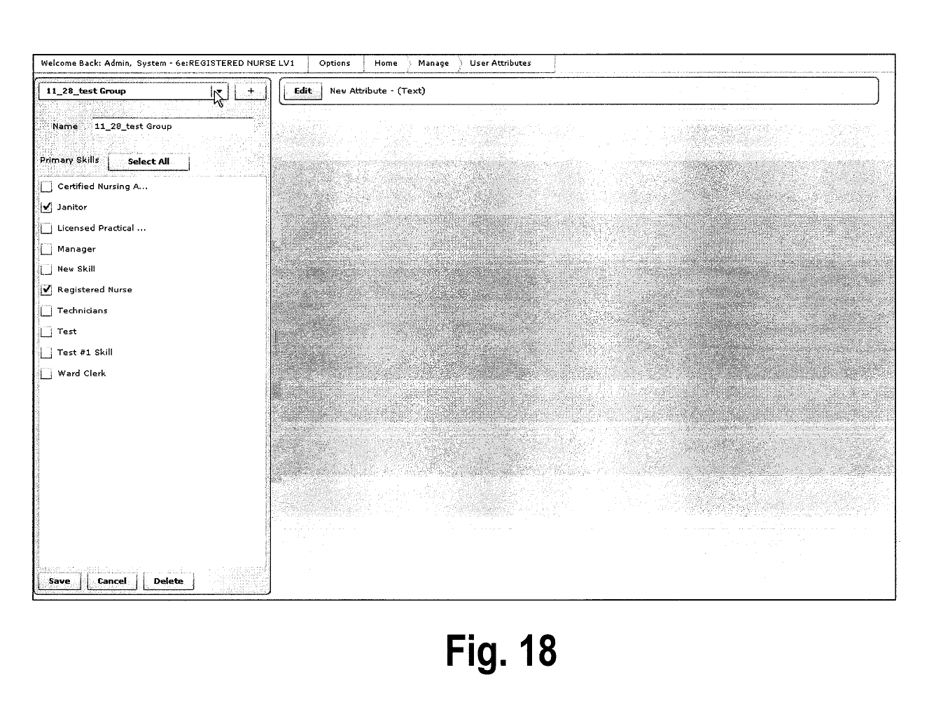

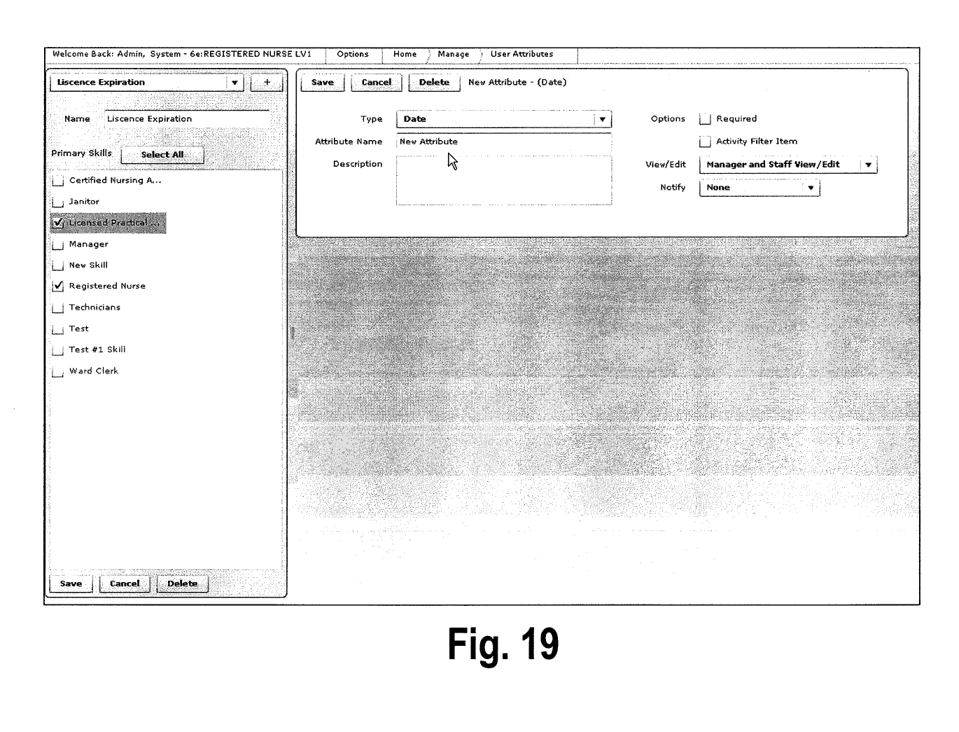

In one embodiment, as indicated, each of the work requirements can be customized based on the units of work (e.g., via a requirements module 260). For example, as shown in FIGS. 18 and 19, work requirements can be added, deleted, or edited to fully customize the work requirements for defining a unit of work.

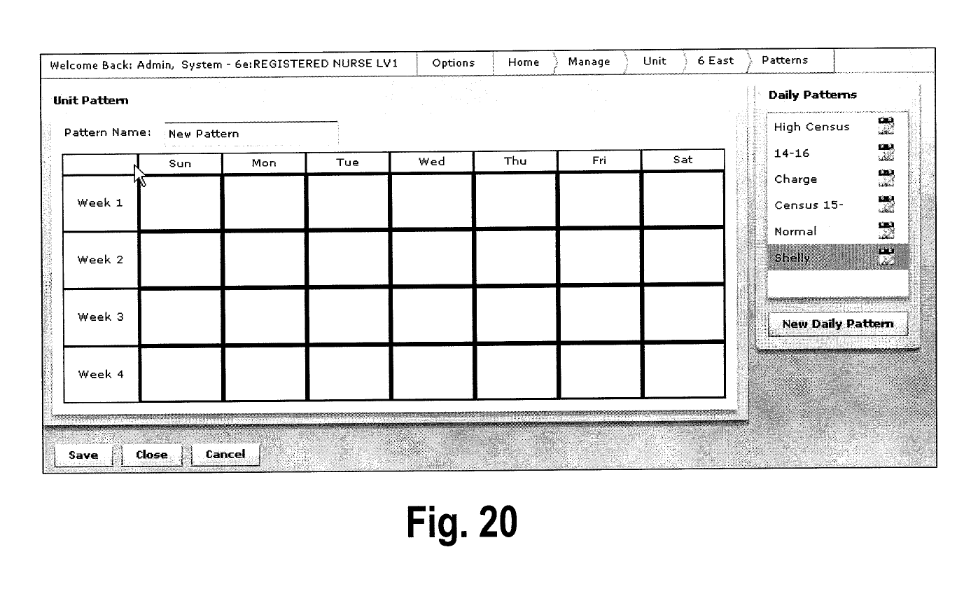

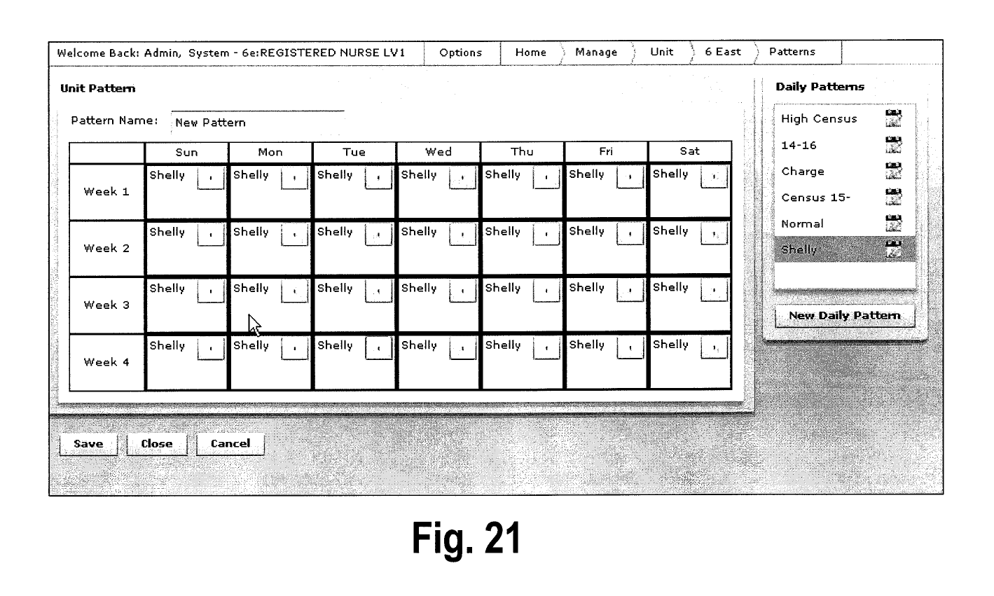

In one embodiment, after a unit of work has been input into the scheduling system 100, the scheduling system 100 (e.g., via user computing devices 110) can store the unit of work as a unit of work template. For example, as shown in FIGS. 20 and 21, a unit of work can be named (e.g., via user computing devices 110) and stored by the scheduling system 100 for duplication of the unit of work that, for example, can be applied to other days, weeks, months, or scheduling periods. In various embodiments, this functionality allows the user to create and save unit of work templates that, for example, occur Monday-Friday every week of the year.

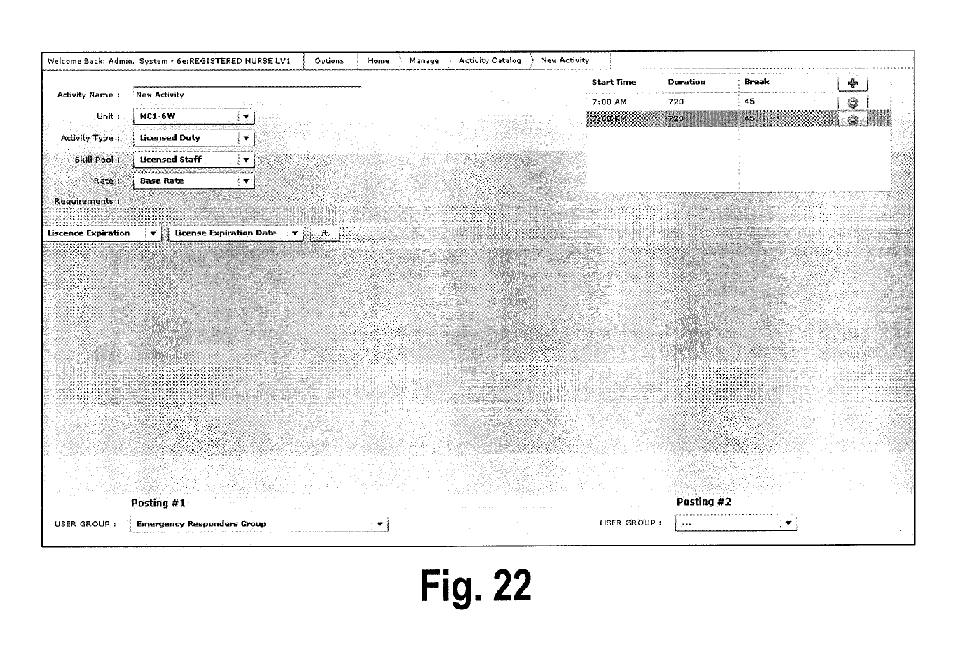

In one embodiment, once a unit of work has been defined, the unit of work can be viewed, posted, and assigned. For example, as indicated in Block 325, the scheduling system 100 receives input (e.g., via a user computing device 110) requesting that a unit of work be posted. In response to receiving this input, the scheduling system 100 can generate a notification that the unit of work is available for assignment. This posting of a unit of work may include a posting strategy, such as the posting strategy shown in FIG. 22. The posting strategy may include, for example, generating notifications to certain worker groups (e.g., the emergency responder group) or managers of certain departments that a unit of work is available for assignment. Similarly, the posting strategy may include incentives, such as indicating that the workers assigned to the unit of work will be paid $2.00 over their base rates of pay for completion of the unit of work. The posting strategies may vary and be customized to suit a variety of needs.

### 5. Automated Scheduling Operation

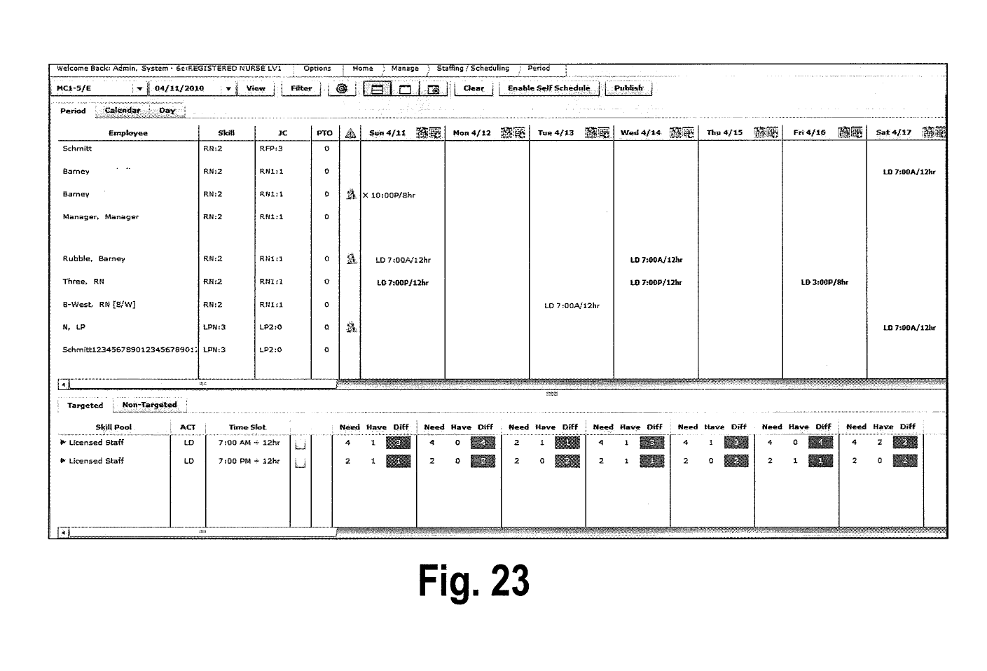

In one embodiment, once a user with a qualifying access level (e.g., based on the user profile) logs onto the scheduling system 100 (e.g., via a user computing device 110), units of work can be assigned. To begin the assignment of units of work, the scheduling system 100 receives input (e.g., from a user via operation of a user computing device 110) requesting the execution of an automated scheduling operation (Block 335). The automated scheduling operation may be, for example, the automatic identification (a) of units of work to which worker profiles can be assigned or (b) of worker profiles that can be assigned to a unit of work (e.g., via a scheduling module 250). Thus, the automated scheduling operation may be a bidirectional operation (see, e.g., FIG. 23). Each direction of the operation is discussed separately below.

i. Automated Unit of Work Identification

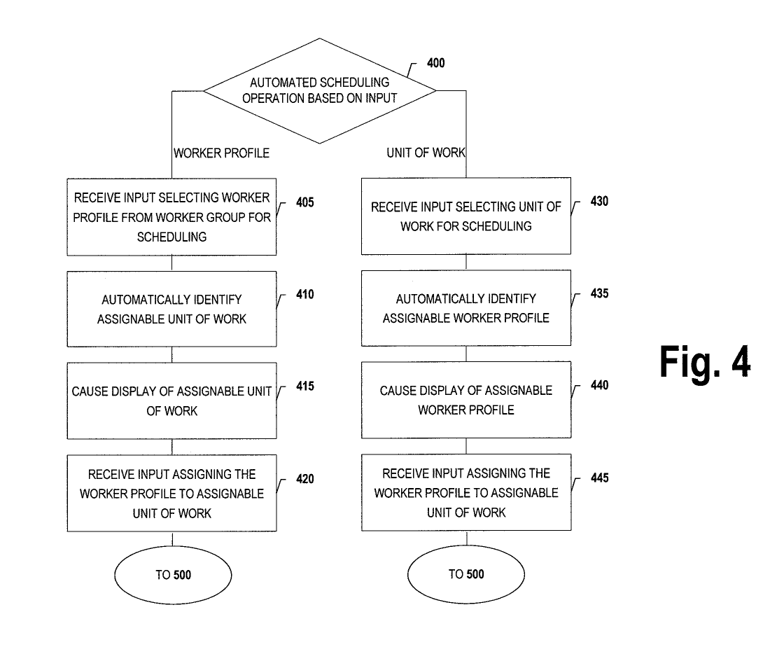

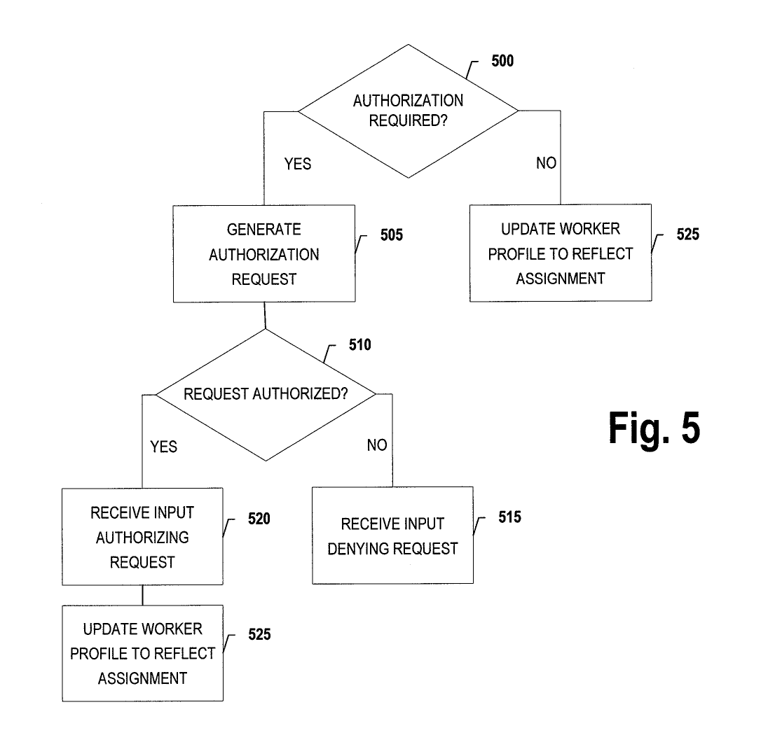

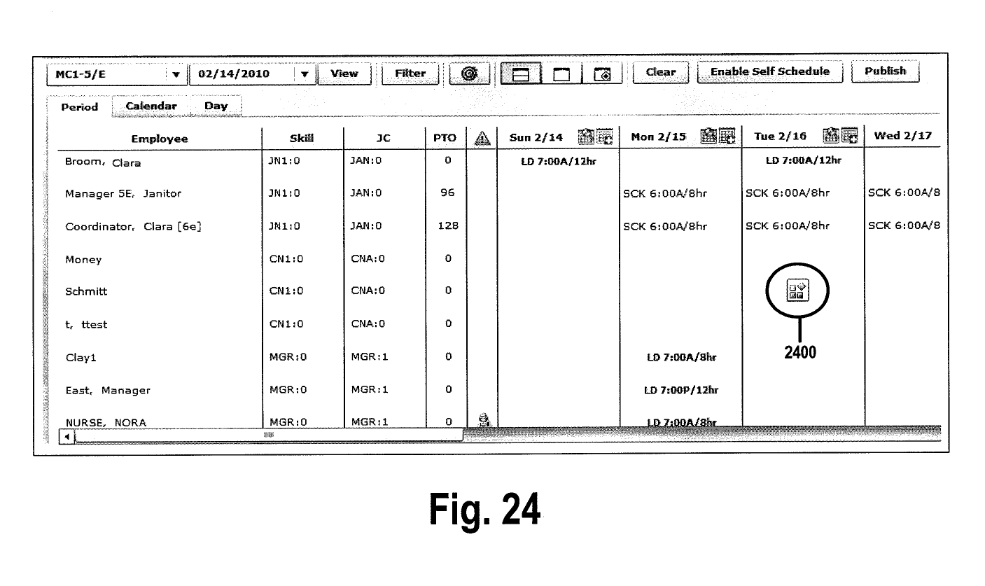

In one embodiment, as indicated in FIGS. 4 and 5, in response to receiving input requesting the execution of an automated scheduling operation (e.g., via a user operating a user computing device 110), the scheduling system 100 performs the requested automated scheduling operation (Block 400). For example, if the automated scheduling operation is for the automatic identification of units of work to which a worker profile can be assigned (Block 405), the scheduling system 100 automatically identifies one or more assignable units of work for the worker profile (e.g., units of work to which the worker profile can be assigned). Thus, if a user with a corresponding manager profile logs on to the scheduling system 100 to schedule “Schmitt” for work on February 16, the user could click on or select an icon 2400 (shown in FIG. 24) corresponding to Schmitt and February 16. In response to receiving this input, the scheduling system 100 automatically identifies assignable units of work for Schmitt on February 16 (e.g., units of work to which Schmitt could be assigned to perform on February 16).

In one embodiment, to perform this operation, as indicated in Block 410, the scheduling system 100 automatically identifies the units of work (a) for which the manager profile can make assignments (e.g., worker groups associated with the user profile), (b) to which Schmitt is qualified to be assigned, (c) that comply with the first rule (e.g., assignments that would not result in scheduling conflicts), and (d) optionally that comply with the second rule with authorization from the appropriate party (e.g., assignments that may require authorization to approve such as overtime). Continuing with the above example, Schmitt's attributes in her worker profile may indicate that she (a) is an RN with a work/job class of “RN1” and (b) speaks Spanish. Accordingly, the scheduling system 100 evaluates the units of work for February 16 and eliminates (e.g., filters) any units of work for which Schmitt is not qualified (e.g., based on Schmitt's primary skill, work/job class, or other attributes).

The scheduling system 100 then evaluates (e.g., filters) the remaining units of work for compliance with the first rule and/or second rule (or first and/or second sets of rules) to determine if assignment of any of the remaining units of work would result in the infraction of a rule. If assigning the worker profile to a unit of work would infract the first rule (or first set of rules), the scheduling system 100 eliminates (e.g., filters) the unit of work from the remaining units of work. If, however, assigning the worker profile to a unit of work would infract the second rule (or second set of rules) but can be assigned with approval by the appropriate party, the scheduling system 100 does not eliminate (e.g., filter) the unit of work from the remaining units of work. After evaluating the rules (or sets of rules), the resultant units of work are the “assignable units of work.” For example, the assignable units of work may be the units of work (a) for which Schmitt is qualified to perform, (b) that would not result in the violation of the first rule, and/or (c) that could be assigned to Schmitt, based on the second rule, with authorization from the appropriate party. It should be noted that the order of the evaluation (e.g., filtering) may vary and that both the first and second rules may be applied optionally.

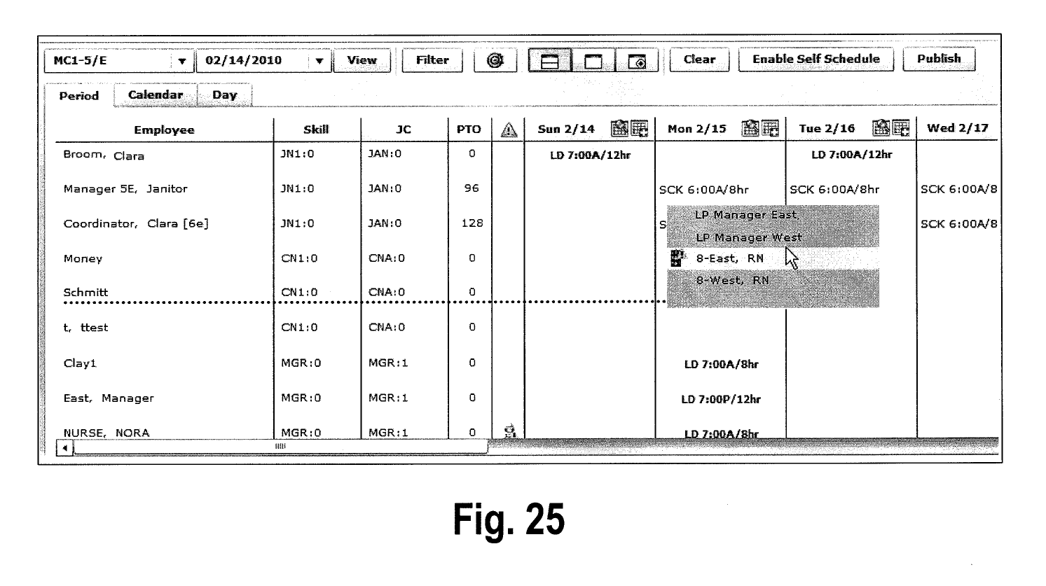

Continuing with the above example, in one embodiment, the scheduling system 100 then causes display of the assignable units of work (Block 415). For example, as shown in FIG. 25, the assignable units of work for Schmitt on February 16 may be the (1) LP Manager East; (2) LP Manager West; (3) 8-East, RN; and (4) 8-West, RN units of work. In addition to or alternatively, the scheduling system 100 may cause display of the assignable units of work with different information (not shown), such as (1) a 7:00 am 12 hour shift that could be filled by an RN or LPN of any work/job class, (2) a 3:00 pm 8 hour shift to work as the charge nurse that could only be filled by an RN with one of three work/job classes, or (3) a 7:00 am 8 hour shift to work productive duty that has to be filled by a Spanish-speaking RN only of any work/job class.

In addition to causing display of the assignable units of work, the scheduling system 100 can cause display of other information as well. For example, as seen in FIG. 25, the icon (e.g., glyph) next to the “8-East, RN” unit of work may indicate that to assign the work unit to Schmitt, authorization to infract the second rule is required. The scheduling system 100 can also cause display of additional information regarding an assignable unit of work, such as (a) the base rate of pay for the unit of work or (b) the type of authorization that would be required to assign the unit of work. Operatively, for example, the scheduling system 100 can cause display of this information in response to a user (e.g., via a user computing device 110) mousing or hovering over an icon associated with a unit of work (or over the text listing a unit of work). There are a variety of approaches and techniques that can be used to cause display of this information to the user.

In one embodiment, the scheduling system 100 causes display of the assignable units of work in a specific order, such as an order displaying the assignable work units in a hardest-to-easiest to fulfill order. To make such a hardest-to-easiest to fulfill determination, the scheduling system 100 may implement a variety of approaches and techniques. In one embodiment, each unit of work may be assigned a weight determined by a starting value (e.g., 100) that is increased or reduced based on certain factors. For example, the starting value (e.g., 100) may be reduced based on work requirements for the unit of work, such as reducing the starting value by 1 point for every work/job class that can be assigned to the unit of work. Similarly, the starting value can be increased by, for example, adding two points for each work requirement necessary to be assigned to the unit of work. The preceding describes an exemplary approach for assigning weights to units of work, which can then be presented in an ascending or descending order.

In one embodiment, as indicated in Block 420, after causing display of the assignable units of work, the scheduling system 100 receives input assigning the worker profile to an assignable unit of work(s) (e.g., via a user, operating a user computing device 110, selecting a unit of work to assign to a worker profile). If authorization is not required to assign the assignable unit of work to the worker profile (e.g., to be in compliance with the second rule), the scheduling system 100 updates the worker profile to reflect the assignment of the assignable unit of work and indicates that the unit of work has been assigned (Blocks 500 and 525). If authorization is required to assign the assignable unit of work to the worker profile (e.g., to be in compliance with the second rule), the scheduling system 100 automatically generates a request to (a) authorize or (b) deny the assignment of the worker profile to the assignable unit of work (Block 500, 505). In response to receiving an authorization from the appropriate party (Block 510, 520), the scheduling system 100 updates the worker profile to reflect the assignment of the assignable unit of work and indicates that the unit of work has been assigned (Block 525). Otherwise, the scheduling system 100 does not assign the unit of work to the worker profile, such as in the event of a denial of the request for authorization (Block 515).

ii. Automated Worker Profile Identification

In one embodiment, as indicated in FIGS. 4 and 5, in response to receiving input requesting the execution of an automated scheduling operation (e.g., via a user operating a user computing device 110), the scheduling system 100 performs the requested automated scheduling operation (Block 400). For example, if the automated scheduling operation is for the automatic identification of worker profiles that can be assigned to a unit of work (Block 430), the scheduling system 100 automatically identifies one or more assignable worker profiles for the unit of work (e.g., worker profiles that can be assigned to the unit of work). Thus, if a user with a corresponding manager profile logs on to the scheduling system 100 to assign workers (e.g., via their respective worker profiles) to a unit of work (e.g., Licensed Staff on Dec. 21, 2011), the user could click on or select the information corresponding to unit of work. In response to receiving this input, the scheduling system 100 automatically identifies assignable worker profiles for the unit of work (e.g., worker profiles that could be assigned to the unit of work on Dec. 21, 2011).

In one embodiment, to perform this operation, as indicated in Block 435, the scheduling system 100 automatically identifies the worker profiles (a) for which the user can make assignments (e.g., worker groups associated with the user profile), (b) that are qualified to be assigned to the unit of work, (c) that comply with the first rule (e.g., assignments that would not result in scheduling conflicts), and (d) optionally that comply with the second rule with authorization from the appropriate party (e.g., assignments that may require authorization to approve such as overtime). For example, the work requirements of the unit of work may indicate that the worker (a) be an RN with a work/job class of “RN1” and (b) speak Spanish. Accordingly, the scheduling system 100 evaluates the worker profiles and eliminates (e.g., filters) any worker profiles of workers who (a) are not for RNs with a work/job class of RNI and (b) do not speak Spanish. Additional work requirements may also be considered.

The scheduling system 100 then evaluates (e.g., filters) the remaining worker profiles for compliance with the first rule and/or second rule (or first and/or second sets of rules) to determine if assignment of any of the remaining worker profiles would result in the infraction of a rule. If assignment of a worker profile to the unit of work would infract the first rule (or first set of rules), the scheduling system 100 eliminates (e.g., filters) the worker profile from the remaining worker profiles. If, however, assignment of a worker profile to the unit of work would infract the second rule (or second set of rules) but can be assigned with approval by the appropriate party, the scheduling system 100 does not eliminate (e.g., filter) the worker profile from the remaining worker profiles. After evaluating the rules (or sets of rules), the resultant worker profiles are the “assignable worker profiles.” It should be noted that the order of the evaluation (e.g., filtering) may vary and that both the first and second rules may be applied optionally.

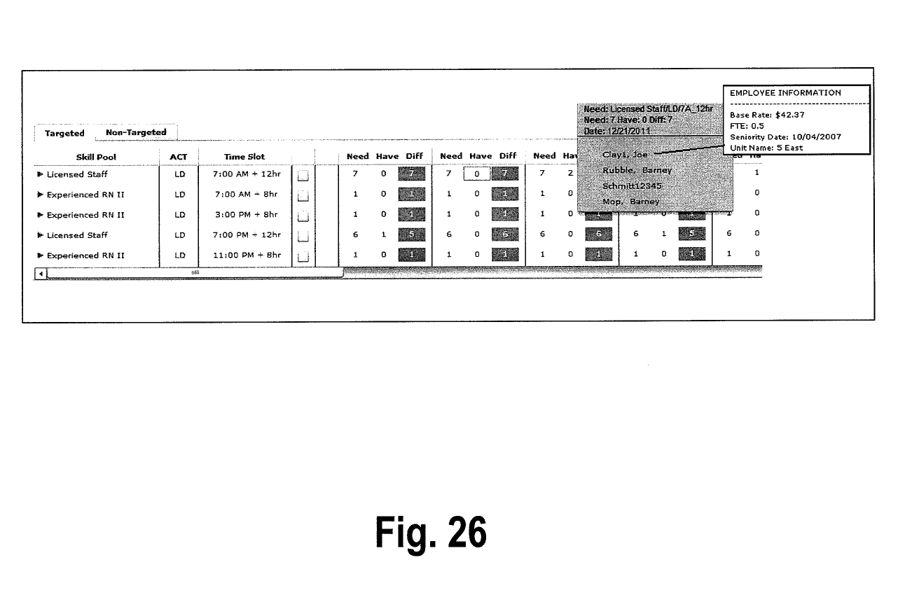

Continuing with the above example, in one embodiment, the scheduling system 100 then causes display of the assignable worker profiles (Block 440). For example, as shown in FIG. 26, the assignable worker profiles that are displayed may be (a) Joe Clay1, (b) Barney Rubble, (c) Schmitt12345, and (d) Barney Mop. In addition to causing display of the assignable worker profiles, the scheduling system 100 can cause display of other information as well. For example, as seen in FIG. 26, the scheduling system 100 can cause display of information from the various worker profiles. For example, when a user operating a user computing device 110 hovers or mouses over a name from an assignable worker profile (or selects an icon next to a worker's name), the scheduling system 100 may cause display of information, such as the worker's (a) base rate of pay, (b) FTE value, (c) seniority date, or (d) home team of workers. Additionally, the scheduling system 100 may cause display of the type of authorization that would be required to assign a worker profile to the unit of work.

In one embodiment, as indicated in Block 445, after causing display of the assignable worker profiles, the scheduling system 100 receives input assigning an assignable worker profile to the unit of work (e.g., via a user, operating a user computing device 110). If authorization is not required to assign the assignable worker profile to the unit of work (e.g., to be in compliance with the second rule), the scheduling system 100 updates the worker profile to reflect the assignment of the assignable worker profile to the unit of work and indicates that the unit of work has been assigned (Blocks 500 and 525). If authorization is required to assign the assignable worker profile to the unit of work (e.g., to be in compliance with the second rule), the scheduling system 100 automatically generates a request to (a) authorize or (b) deny the assignment of the assignable worker profile to the unit of work (Block 500, 505). In response to receiving an authorization from the appropriate party (Block 510, 520), the scheduling system 100 updates the assignable worker profile to reflect the assignment of the unit of work and indicates that the unit of work has been assigned (Block 525). Otherwise, the scheduling system 100 does not assign the unit of work to the worker profile, such as in the event of a denial of the request for authorization (Block 515).

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for scheduling and assigning units of work, the computer-implemented method comprising:
electronically storing a plurality of worker profiles corresponding respectively to a plurality of workers;
electronically storing one or more worker groups, wherein each of the one or more worker groups is associated with a plurality of worker profiles;
electronically storing a first rule that requires compliance with for a worker profile to be assigned to a unit of work;
electronically storing a second rule that requires authorization for a worker profile to be assigned to a unit of work;
receiving, via one or more processors, input defining a plurality of units of work;
receiving, via the one or more processors, input identifying a user associated with a user profile;
receiving input requesting execution of an automated scheduling operation, wherein execution of the automated scheduling function comprises (a) electronically identifying at least one worker group associated with the user profile and (b) receiving input selecting a worker profile from the worker group for scheduling;
receiving, via the one or more processors, input assigning the worker profile to an assignable unit of work;
in response to receiving input assigning the worker profile to the assignable unit of work that would require authorization to be in compliance with the second rule, generating a request to (a) authorize or (b) deny the assignment of the worker profile to the assignable unit of work;
receiving, via the one or more processors, input authorizing the assignment of the worker profile to the assignable unit of work; and
updating, via the one or more processors, the worker profile to reflect the assignment of the assignable unit of work.

2. A computer-implemented method for scheduling and assigning units of work, the computer-implemented method comprising:
electronically storing a plurality of worker profiles corresponding respectively to a plurality of workers;
electronically storing one or more worker groups, wherein each of the one or more worker groups is associated with a plurality of worker profiles;
electronically storing a first rule that requires compliance with for a worker profile to be assigned to a unit of work;
receiving, via the one or more processors, input defining a plurality of units of work;
receiving, via the one or more processors, input identifying a user associated with a user profile; and
receiving, via the one or more processors, input requesting execution of an automated scheduling operation.

3. The computer-implemented method of claim 2 further comprising electronically storing a second rule that requires authorization for a worker profile to be assigned to a unit of work.

4. The computer-implemented method of claim 3, wherein the automated scheduling operation further comprises:
electronically identifying at least one worker group associated with the user profile; and
receiving, via the one or more processors, input selecting a worker profile from the worker group for scheduling.

5. The computer-implemented method of claim 4 further comprising:
in response to receiving input selecting the worker profile from the worker group for scheduling, automatically identifying an assignable unit of work (a) for which the attributes associated with the worker profile substantially comply with the work requirements associated with the assignable unit of work, (b) that would result in compliance with the first rule provided the worker profile is assigned to the assignable unit of work, and (c) that would require authorization to be in compliance with the second rule to assign the worker profile to the assignable unit of work; and
causing display of the assignable unit of work.

6. The computer-implemented method of claim 5 further comprising:
receiving input assigning the worker profile to the assignable unit of work;
in response to receiving input assigning the worker profile to the assignable unit of work that would require authorization to be in compliance with the second rule, generating a request to (a) authorize or (b) deny the assignment of the worker profile to the assignable unit of work;
receiving, via the one or more processors, input authorizing the assignment of the worker profile to the assignable unit of work; and
updating, via the one or more processors, the worker profile to reflect the assignment of the assignable unit of work.

7. The computer-implemented method of claim 4 further comprising:
in response to receiving input selecting the worker profile from the worker group for scheduling, automatically identifying an assignable unit of work (a) for which the attributes associated with the worker profile substantially comply with the work requirements associated with the assignable unit of work and (b) that would result in compliance with the first rule provided the worker profile is assigned to the assignable unit of work;
causing display of the assignable unit of work;
receiving, via the one or more processors, input assigning the worker profile to the assignable unit; and
updating, via the one or more processors, the worker profile to reflect the assignment of the assignable unit of work.

8. The computer-implemented method of claim 3, wherein the automated scheduling operation further comprises:
electronically, via the one or more processors, identifying at least one worker group associated with the user profile; and
receiving, via the one or more processors, input selecting a unit of work for scheduling.

9. The computer-implemented method of claim 8 further comprising:
in response to receiving input selecting a unit of work for scheduling, automatically identifying an assignable worker profile (a) for which the attributes of each of the assignable worker profile substantially comply with the work requirements associated with the unit of work, (b) that would result in compliance with the first rule provided the assignable worker profile is assigned to the unit of work, and (c) that would require authorization to be in compliance with the second rule to assign the assignable worker profile to the unit of work; and
causing display of the assignable worker profile.

10. The computer-implemented method of claim 9 further comprising:
receiving input assigning the assignable worker profile to the unit of work;
in response to receiving input assigning the assignable worker profile to the unit of work, generating a request to (a) authorize or (b) deny the assignment of the assignable worker profile to the unit of work;
receiving input (a) denying or (b) authorizing the assignment of the assignable worker profile to the unit of work; and
updating the assignable worker profile to reflect the assignment of the unit of work.

11. The computer-implemented method of claim 10 further comprising:
in response to receiving input selecting a unit of work for scheduling, automatically identifying an assignable worker profile (a) for which the attributes of the assignable worker profile substantially comply with the work requirements associated with the unit of work and (b) that would result in compliance with the first rule provided the assignable worker profile is assigned to the unit of work;
causing display of the assignable worker profile;
receiving, via the one or more processors, input assigning assignable worker profile to the unit of work; and
updating, via the one or more processors, the assignable worker profile to reflect the assigned unit of work.

12. The computer-implemented method of claim 3, wherein each of the respective worker profiles comprises one or more attributes selected from the group consisting of (a) a primary skill, (b) a base rate of pay, (c) a work class, and (d) languages spoken.

13. The computer-implemented method of claim 12, wherein each of the respective units of work comprises one or more work requirements selected from the group consisting of (a) a primary skill, (b) a base rate of pay, (c) a work class, (d) languages spoken, (e) a start time, and (f) an end time.

14. A computer program product for scheduling and assigning units of work, the computer program product comprising at least one computer-readable storage medium having computer-readable program code portions stored therein, the computer-readable program code portions comprising:
an executable portion configured to store a plurality of worker profiles corresponding respectively to a plurality of workers;
an executable portion configured to store one or more worker groups, wherein each of the one or more worker groups is associated with a plurality of worker profiles;
an executable portion configured to store a first rule that requires compliance with for a worker profile to be assigned to a unit of work;
an executable portion configured to store a second rule that requires authorization for a worker profile to be assigned to a unit of work;
an executable portion configured to receive input defining a plurality of units of work;
an executable portion configured to receive input identifying a user associated with a user profile;
an executable portion configured to receive input requesting execution of an automated scheduling operation, wherein execution of the automated scheduling function comprises (a) electronically identifying at least one worker group associated with the user profile and (b) receiving input selecting a worker profile from the worker group for scheduling;
an executable portion configured to receive input assigning the worker profile to an assignable unit of work;
an executable portion configured to, in response to receiving input assigning the worker profile to the assignable unit of work that would require authorization to be in compliance with the second rule, generate a request to (a) authorize or (b) deny the assignment of the worker profile to the assignable unit of work;
an executable portion configured to receive input authorizing the assignment of the worker profile to the assignable unit of work; and
an executable portion configured to update the worker profile to reflect the assignment of the assignable unit of work.

15. A computer program product for scheduling and assigning units of work, the computer program product comprising at least one computer-readable storage medium having computer-readable program code portions stored therein, the computer-readable program code portions comprising:
an executable portion configured to store a plurality of worker profiles corresponding respectively to a plurality of workers;
an executable portion configured to store one or more worker groups, wherein each of the one or more worker groups is associated with a plurality of worker profiles;
an executable portion configured to store a first rule that requires compliance with for a worker profile to be assigned to a unit of work;
an executable portion configured to receive input defining a plurality of units of work;
an executable portion configured to receive input identifying a user associated with a user profile; and
an executable portion configured to receive input requesting execution of an automated scheduling operation.

16. The computer program product of claim 15 further comprising an executable portion configured to store a second rule that requires authorization for a worker profile to be assigned to a unit of work.

17. The computer program product of claim 16, wherein the executable portion configured to execute the automated scheduling operation further comprises:
an executable portion configured to identify at least one worker group associated with the user profile; and
an executable portion configured to receive input selecting a worker profile from the worker group for scheduling.

18. The computer program product of claim 17 further comprising:
an executable portion configured to, in response to receiving input selecting the worker profile from the worker group for scheduling, automatically identify an assignable unit of work (a) for which the attributes associated with the worker profile substantially comply with the work requirements associated with the assignable unit of work, (b) that would result in compliance with the first rule provided the worker profile is assigned to the assignable unit of work, and (c) that would require authorization to be in compliance with the second rule to assign the worker profile to the assignable unit of work; and
an executable portion configured to cause display of the assignable unit of work.

19. The computer program product of claim 18 further comprising:
an executable portion configured to receive input assigning the worker profile to the assignable unit of work;
an executable portion configured to, in response to receiving input assigning the worker profile to the assignable unit of work that would require authorization to be in compliance with the second rule, generate a request to (a) authorize or (b) deny the assignment of the worker profile to the assignable unit of work;
an executable portion configured to receive input authorizing the assignment of the worker profile to the assignable unit of work; and
an executable portion configured to update the worker profile to reflect the assignment of the assignable unit of work.

20. The computer program product of claim 17 further comprising:
an executable portion configured to, in response to receiving input selecting the worker profile from the worker group for scheduling, automatically identify an assignable unit of work (a) for which the attributes associated with the worker profile substantially comply with the work requirements associated with the assignable unit of work and (b) that would result in compliance with the first rule provided the worker profile is assigned to the assignable unit of work;
an executable portion configured to cause display of the assignable unit of work;
an executable portion configured to receive input assigning the worker profile to the assignable unit; and
an executable portion configured to update the worker profile to reflect the assignment of the assignable unit of work.

21. The computer program product of claim 16, wherein the executable portion configured to execute the automated scheduling operation further comprises:
an executable portion configured to identify at least one worker group associated with the user profile; and
an executable portion configured to receive input selecting a unit of work for scheduling.

22. The computer program product of claim 21 further comprising:
an executable portion configured to, in response to receiving input selecting a unit of work for scheduling, automatically identify an assignable worker profile (a) for which the attributes of each of the assignable worker profile substantially comply with the work requirements associated with the unit of work, (b) that would result in compliance with the first rule provided the assignable worker profile is assigned to the unit of work, and (c) that would require authorization to be in compliance with the second rule to assign the assignable worker profile to the unit of work; and
an executable portion configured to cause display of the assignable worker profile.

23. The computer program product of claim 22 further comprising:
an executable portion configured to receive input assigning the assignable worker profile to the unit of work;
an executable portion configured to, in response to receiving input assigning the assignable worker profile to the unit of work, generate a request to (a) authorize or (b) deny the assignment of the assignable worker profile to the unit of work;
an executable portion configured to receive input (a) denying or (b) authorizing the assignment of the assignable worker profile to the unit of work; and
an executable portion configured to update the assignable worker profile to reflect the assignment of the unit of work.

24. The computer program product of claim 23 further comprising:
an executable portion configured to, in response to receiving input selecting a unit of work for scheduling, automatically identify an assignable worker profile (a) for which the attributes of the assignable worker profile substantially comply with the work requirements associated with the unit of work and (b) that would result in compliance with the first rule provided the assignable worker profile is assigned to the unit of work;
an executable portion configured to cause display of the assignable worker profile;
an executable portion configured to receive input assigning assignable worker profile to the unit of work; and
an executable portion configured to update the assignable worker profile to reflect the assigned unit of work.
